(19) United States
(12) Patent Application Publication
(10) Pub. No.: US 2008/0216624 A1
(43) Pub. Date: Sep. 11, 2008

(54) PUNCH DIE AND METHOD FOR MAKING A HIGH QUALITY CUT SURFACE ON A METAL WORKPIECE

(75) Inventor: ZHI-DA LIU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 11/845,096

(22) Filed: Aug. 27, 2007

(30) Foreign Application Priority Data
Mar. 7, 2007 (CN) 200710200254.8

(51) Int. Cl. B26D 1/01

(52) U.S. Cl. 83/51; 83/681

(57) ABSTRACT

An exemplary punch die (200) for making a high quality cut surface (301) on a metal workpiece (31) includes an upper die (21) and a lower die (22). A burnish occupies 90% of the whole cut surface. A cutting clearance between the upper die and the lower die is 0.5% T or less, T is thickness of the metal workpiece. A method for making a high quality cut surface on a metal workpiece includes: providing a lower die, and mounting a metal workpiece on the lower die; providing an upper die, and a cutting clearance between the upper die and lower die is 0.5% T or less, T is thickness of the metal workpiece; and forming a cut surface on the metal workpiece by the upper die and the lower die, and the burnish occupies 90% of the entire cut surface.

### BACKGROUND OF THE INVENTION

1. Field of the Invention

The present invention generally relates to punch dies, and more particularly to a punch die that can make a high quality cut surface on a metal workpiece. The present invention also relates to a method for making a high quality cut surface on a metal workpiece.

2. Discussion of the Related Art

Referring to FIG. 4, when using conventional punch die to punch holes or cut marginal portions for a metal workpiece 10, such as a metal sheet, a cut surface of the workpiece 10 generally includes a collapsed edge 11, a burnish 12, a tear band 13, and a burr side 14. The amount of the burnish 12 determines the quality of the cut surface. The quality of the cut surface affects an appearance of the workpiece 10, the higher the quality of the cut surface, the better the appearance of the workpiece 10.

Referring also to FIG. 5, a typical punch die 100 for cutting marginal portions of the metal workpiece 10 includes an upper die 101, and a lower die 102. A cutting clearance L between the upper die 101 and the lower die 102 affects the quality of the cut surface of the metal workpiece 10. Generally, the greater a thickness of the metal workpiece 10, the greater the cutting clearance L. However, if the cutting clearance L is too great, drawing stress increases, the metal workpiece 10 would be prone to tear so that the burnish 12 of the cut surface decreases and the collapsed edge 11 increases.

The burnish 12 of the cut surface of the metal workpiece 10 only occupies about 30% of the entire cut surface. Surface roughness of the metal sheet is in a range from Ra 12.5 μm to Ra 6.3 μm. It does not meet the requirement when metal workpieces with high quality cut surfaces are needed. In order to obtain cut surfaces with higher quality on metal workpieces, expensive equipments are usually required. Expensive equipments increase manufacturing costs greatly. Another solution is to machine the cut surface of the sheet via numerical control machine. However, the numerical control machine is expensive as well. In addition, the numerical control machine should machine the metal sheets one by one, thus the solution of machining the cut surface of the sheet via numerical control machine is not ideal for mass production.

Therefore, a new punch die is desired in order to overcome the above-described shortcomings. A new method for making a high quality cut surface on metal workpieces is also desired.

### SUMMARY

In one aspect, a punch die for making a high quality cut surface on a metal workpiece includes an upper die and a lower die. A burnish occupies 90% of the entire cut surface. A cutting clearance between the upper die and the lower die is 0.5% T or less, T is thickness of the metal workpiece.

In another aspect, a method for making a high quality cut surface on a metal workpiece, includes: providing a lower die, and mounting a metal workpiece on the lower die; providing an upper die, and a cutting clearance between the upper die and lower die is 0.5% T or less, T is thickness of the metal workpiece; and forming a cut surface on the metal workpiece by the upper die and the lower die, and the burnish occupies 90% of the entire cut surface.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles and methodology of the punch die. Moreover, in the drawings, like reference numerals designate corresponding parts throughout the several views.

FIG. 1 is a schematic, cross-sectional view of a first state of a punch die in accordance with the present invention, showing the punch die is going to make a cut surface on a metal workpiece.

FIG. 2 is similar to FIG. 1, but showing a second state of the punch die and the punch die is making a cut surface on the metal workpiece.

FIG. 3 is a schematic, cross-sectional view of a punched product made by the punch die of FIG. 1.

FIG. 4 is a schematic, cross-sectional view of a metal workpiece obtained via a conventional punch die.

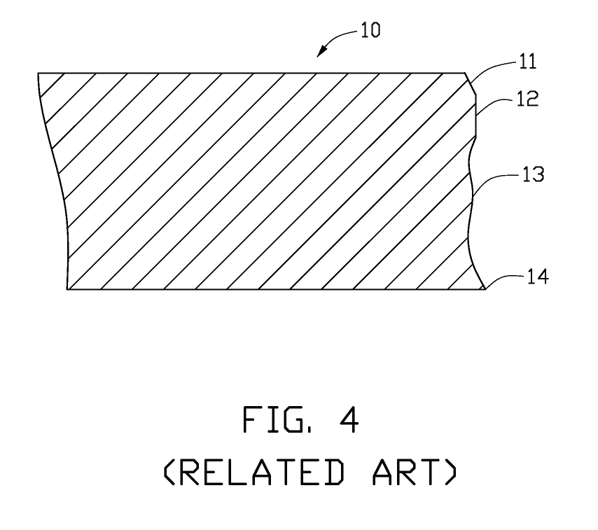

FIG. 5 is a schematic, cross-sectional view of a conventional punch die for making a cut surface on the metal workpiece of FIG. 4.

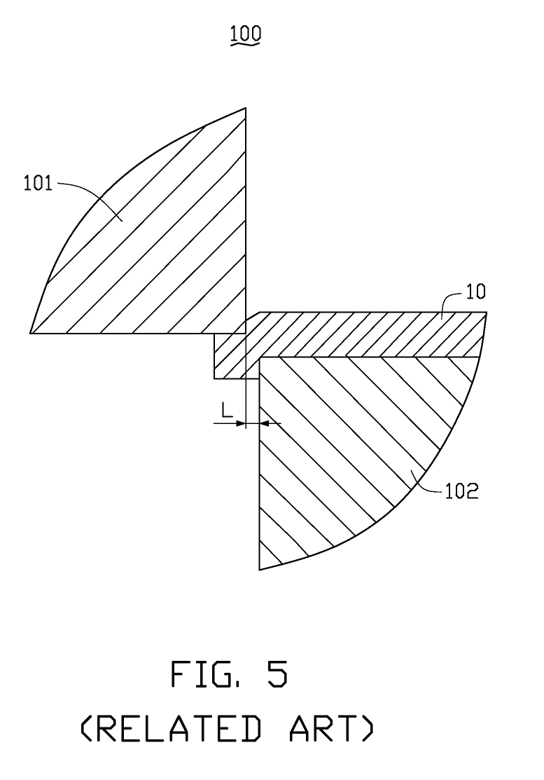

### DETAILED DESCRIPTION OF THE EMBODIMENTS

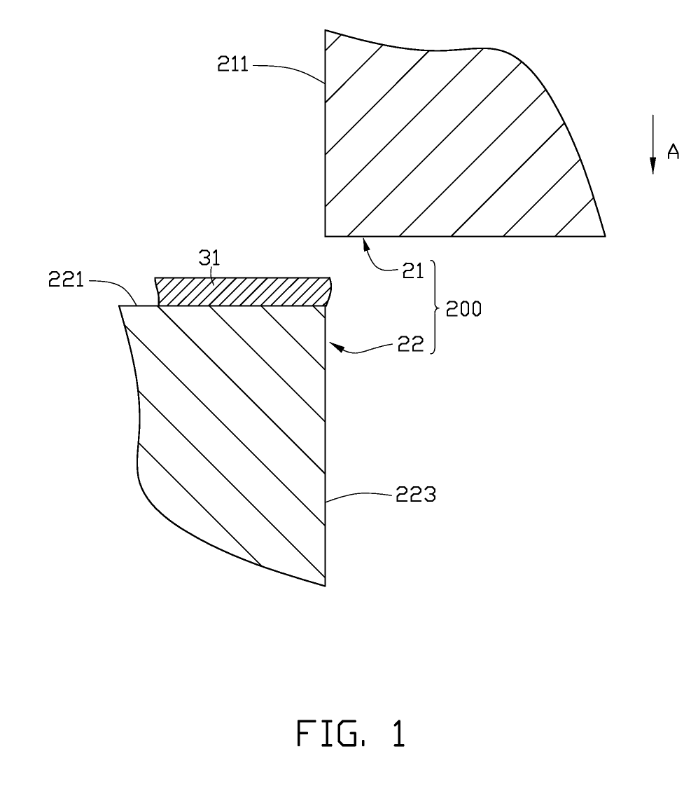

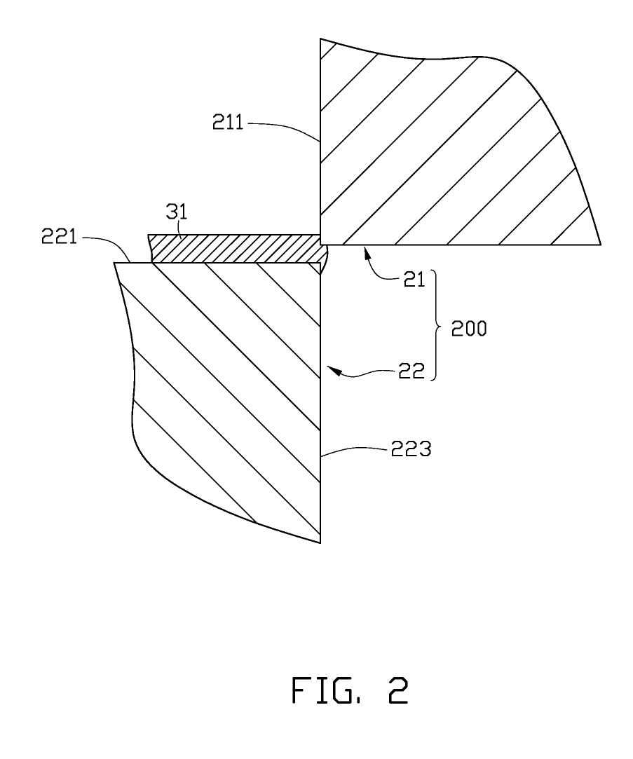

Referring to FIG. 1 and FIG. 2, a punch die 200 in accordance with the preferred embodiment of the present invention is applied to make a high quality cut surface on a metal workpiece 31. The punch die 200 is applicable not only to aluminum workpiece or copper workpiece, but also to low-carbon steel workpiece whose carbon content is less than 0.15%. A thickness of the metal workpiece 31 is in a range from about 2 mm to about 12 mm.

The punch die 200 includes an upper die 21 and a lower die 22. The upper die 21 includes a work face 211 for cutting the metal workpiece 31. The lower die 22 includes a platform 221 and a side surface 223 perpendicular to the platform 221. The metal workpiece 31 can be fixed on the platform 221. A cutting clearance between the upper die 21 and the lower die 22 is zero, thus the work face 211 of the upper die 21 and the side surface 223 of the lower die 22 are coplanar

A method for making a high quality cut surface on the metal workpiece 31 includes the following steps. The metal workpiece 31 is fixed on the platform 221 of the lower die 22. A portion of the metal workpiece 31 facing the side surface 223 extends out of the platform 221. The upper die 21 is moved toward the lower die 22 along a direction A, and then the upper die 21 cuts the metal workpiece 31.

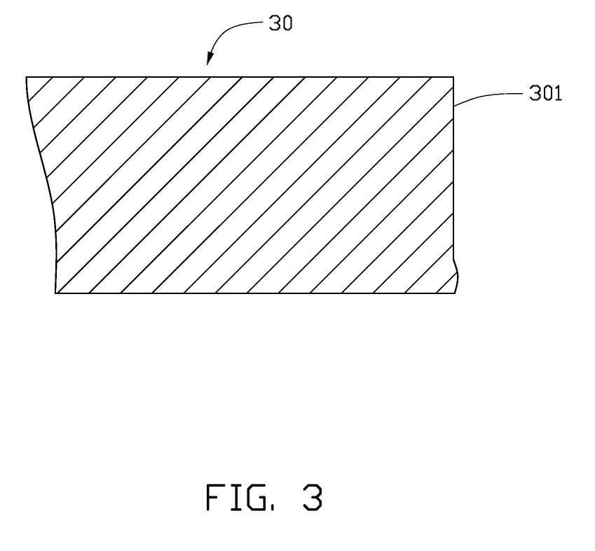

Referring to FIG. 3, the metal workpiece 31 is made into a punched product 30 by the work face 211 of the upper die 21 and the lower die 22. A cut surface 301 is formed on the punched product 30.

In an alternative embodiment, in order to obtain high degree of finish, a rough blanking is usually applied to obtain a rough cut surface before a fine blanking by using the punch die 200 is applied to obtain the cut surface 301. The rough blanking can reduce influences from the cutting clearance, chipping allowance, and holding pressure on the quality of the cut surface 301. In the rough blanking, equal or similar parameters as the conventional cutting technology are chosen to eliminate the great mass of surplus of the metal workpiece 31. When the punch die 200 is applied to obtain the cut surface 301, only a little surplus of the metal workpiece 31 is removed from the metal workpiece 31, thereby preventing a tear band and burrs forming at a lower portion of the cut surface 103 and increasing the quality of the cut surface 301.

Since the cutting clearance of the punch die 200 is zero, the punched product 30 formed by the punch die 200 has a burnish that occupies 90% of an entire cut surface 301, and has the cut surface that meets a high quality requirement.

Cutting clearance is the most important factor that influences the quality of the cut surface. If cutting clearance is 0.5% T (T is thickness of the metal workpiece 31), the tear band of the cut surface is reduced greatly, and the cut surface meets the high quality requirement. If the cutting clearance is 0.5% T, the metal workpiece 31 with a height of 3 mm will obtain a burnish of 2.8 mm. When the cutting clearance gets smaller, the cut surface will have more burnish. Ultimately, the cutting clearance of fine blanking of the present invention is chosen in a range of equal to or less than 0.5% T.

In an alternative embodiment, a method for making the punched product can only includes the following step. A lower die is provided, and a metal workpiece is mounted on the lower die. An upper die is provided, a cutting clearance between the upper die and lower die is 0.5% T or less (T is thickness of the metal workpiece). A cut surface is formed by the upper die and the lower die, and the burnish occupies 90% of the entire cut surface.

An improved cutting technology in accordance with the preferred embodiment of the present invention is applied to obtain high quality cut surface 301. The cut surface 301 is formed by a rough blanking and several times of fine blankings. In the rough blanking, equal or similar parameters as the conventional cutting technology is chosen to eliminate the great mass of surplus of the sheet. Fine blankings are processed one by one, via gradually reducing the cutting clearance. A close-to-100% burnish of the cut surface 301 is thus achieved, surface roughness of the cut surface 301 is Ra 0.31 μm.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A punch die for making a high quality cut surface on a metal workpiece, and a burnish occupying 90% of the entire cut surface, the punch die comprising:
an upper die; and
a lower die;
wherein a cutting clearance between the upper die and the lower die is 0.5% T or less, wherein T is a thickness of the metal workpiece.

2. The punch die as claimed in claim 1, wherein the cutting clearance is zero.

3. The punch die as claimed in claim 1, wherein the upper die includes a work face for cutting the metal workpiece, and the lower die includes a platform and a side surface perpendicular to the platform, the platform is configured for fixing the metal workpiece.

4. The punch die as claimed in claim 3, wherein the work face of the upper die and the side surface of the lower die are coplanar.

5. The punch die as claimed in claim 1, wherein the metal workpiece is made of materials selected from a group consisting of aluminum, copper, and low-carbon steel whose carbon content is less than 0.15%.

6. The punch die as claimed in claim 1, wherein a thickness of the metal workpiece is in a range from about 2 mm to about 12 mm.

7. A method for making a high quality cut surface on a metal workpiece, comprising:
(1) providing a lower die, and mounting a metal workpiece on the lower die;
(2) providing an upper die, and a cutting clearance between the upper die and lower die is 0.5% T or less, T is thickness of the metal workpiece; and
(3) forming a cut surface on the metal workpiece by the upper die and the lower die, and the burnish occupies 90% of the entire cut surface.

8. The method as claimed in claim 7, wherein the metal material is one of aluminum, copper and low-carbon steels having a carbon content less than 0.15%.

9. The method as claimed in claim 7, wherein a thickness of said metal material is in a range from about 2 mm to about 12 mm.

10. The method as claimed in claim 7, wherein before the step (1), the method further comprising a step: processing the metal workpiece with one rough blanking to eliminate most surplus of the sheet.

11. The method as claimed in claim 7, wherein after the step (3), the method further comprising a step: processing more than one fine blankings one by one, via gradually reducing the cutting clearance.

12. The method as claimed in claim 7, wherein the cutting clearance is zero.

13. The method as claimed in claim 7, wherein the upper die includes a work face for cutting the metal workpiece, and the lower die includes a platform and a side surface perpendicular to the platform, the platform is configured for fixing the metal workpiece.

14. The method as claimed in claim 13, wherein the work face of the upper die and the side surface of the lower die are coplanar.
